(19) United States
(12) Patent Application Publication
(10) Pub. No.: US 2003/0073781 A1
(43) Pub. Date: Apr. 17, 2003

(54) Phosphorus-containing resin and flame retardant resin composition containing the same

(75) Inventors: Kuen-Yuan Hwang, Hsinchu (TW); Hong-Hsing Chen, Hsinchu (TW); An-Pang Tu, Hsinchu (TW)

Correspondence Address: Mr. Peter F. Corless, EDWARDS & ANGELL, LLP, 101 Federal Street, Boston, MA, 02110, US

(73) Assignee: Chang Chun Plastics Co., Ltd., Taipei (TW)

(21) Appl. No.: 09/929,166

(22) Filed: Aug. 14, 2001

(51) Int. Cl. C08F 8/00; C09K 21/00; C08L 63/00; C08G 59/40; C08G 65/00

(52) U.S. Cl. 525/107; 252/601; 252/609; 528/108

(57) ABSTRACT

A phosphorus-containing resin and a flame retardant resin composition containing the same are proposed. The flame retardant resin composition includes a phosphorus-containing resin, a nitrogen-containing resin hardener and a hardening promoter. Since the flame retardant resin composition has an excellent flame retardant property and heat resistance with no halogens contained and no additional flame retardant additives added therein, it can be used for producing prepregs, composite materials, laminates, printed circuit boards, copper foil adhesives, and packaging materials for semiconductors.

### FIELD OF THE INVENTION

The present invention relates to a phosphorus-containing resin and a flame retardant resin composition containing the same.

### BACKGROUND OF THE INVENTION

Due to easy processibility, high safety, excellent mechanical and chemical properties, a composite material, especially an epoxy resin composite material, has been widely used in various fields such as coating, electrical insulating, building materials, adhesives, laminates, etc. As an epoxy resin has strong adhesion to reinforcement materials such as glass fibers, and is not volatile as well as shrinks in small extent when hardening, a laminate made of epoxy resin is provided with many advantages such as a broad range of applicability, excellent mechanical strength, better electrical insulation, good resistance to chemicals, etc. This makes the laminates highly increased in reliability and widely used in electrical and electronic products.

However, in accordance with requirements of fine wires and high density in a printed circuit board, a laminate preferably possesses better mechanical and electrical properties as well as better heat resistant workability. A commonly used FR4 laminate generally has a glass transition temperature of about 130° C. after hardening. In a fabricating process for the printed circuit board, the temperature is over 200° C. during cutting and drilling and even over 270° C. during welding, which may cause the laminate to break or crack. Therefore, various laminates having high thermal stability and high glass transition temperatures are increasingly being developed. Moreover, another important requirement for laminates is a flame retardant property. In certain cases such as airplanes, automobiles, or public transit vehicles which are directly related to human safety, the flame retardant property of the printed circuit board is absolutely necessary.

In order to incorporate the flame retardant property to the laminates, a material having properties for isolating flames and decreasing burning must be introduced. An epoxy resin/glass fabric (or organic fabric) laminate can attain a strict standard for the flame retardant property (such as UL 94V-0 level) through using a halogen-containing compound, especially a bromine-containing epoxy resin and hardener, in combination with a flame retardant such as antimony oxide and the like. Usually, the UL 94V-0 level can only be achieved by using the epoxy resin with bromine content as high as 17% to 21% in combination with antimony oxide or other flame retardants. However, the use of epoxy resins with high bromine content or antimony oxide may be detrimental for human health.

First, antimony oxide has been considered as a carcinogen. Furthermore, during a burning process, bromine will generate corrosive bromine free radicals and hydrogen bromide, and also aromatic compounds with high bromine content will produce toxic furan bromides and dioxin bromide compounds, which may seriously affect human health and the environment. Therefore, in order to solve the current problem of environmental pollution due to the use of epoxy resin bromides in the laminates, it is necessary to find a new flame retardant material and flame retardant method, especially required for a commonly used laminate such as a FR-4 epoxy glass fabric laminate.

Phosphorus compounds have been extensively studied and used as environmental-friendly flame retardans. For example, red phosphorus- or phosphorus-containing organic compounds (such as triphenyl phosphate, tribenzyl phosphate, phosphoric acid, etc.) are directly used as the flame retardants in place of halogen compounds for improving burning properties of polymers or hardened-type resins. However, if the organic compounds are directly added to the resins, a large amount of the compounds is required according to the flame retardant efficiency thereof, and further the low molecular weight of the compounds may generate high migration thereof, which will directly affect the properties of the resins such as electrical properties, adhesion strength and the like, and thus result in difficulty in practical use.

Recently, in consideration of reactive flame retardants together with environmental protection and safety, phospho-epoxy resin has been used in place of bromo-epoxy resin for fabricating the flame retardant laminates. For example, U.S. Pat. No. 5,376,453 discloses the use of phosphates containing epoxy groups in combination with a nitrogen-containing cyclic hardener to produce a laminate. However, in order to achieve the UL 94V-0 standard, various phosphate-containing epoxides are added as a supplement to phosphorus content. U.S. Pat. No. 5,458,978 utilizes epoxy phosphates together with nitrogen-containing epoxy resins and metal complexes as hardeners for producing a product having a glass transition temperature of about 175° C. and a flame retardant property close to the standard of UL 94V-0 (42 seconds, as compared with the critical value of 50 seconds). U.S. Pat. Nos. 4,973,631 and 5,086,156 adopt phosphine oxide having active hydrogen substituents (such as an amino group) to be used alone or in combination with other amine hardeners for hardening the epoxy resin. However, the use of hardeners for introducing phosphorus to the resin undesirably results in low phosphorus content, and further, no measurement for the flame retardant effect is available in these two patents.

According to the above mentioned, the present invention is therefore accomplished so as to improve the defects of the conventional techniques, increase electrical and mechanical properties as well as reduce the fabrication cost.

### DETAILED DESCRIPTION OF THE INVENTION

The present invention relates to a phosphorus-containing resin, which is characterized by the functional group in the following formula (A):

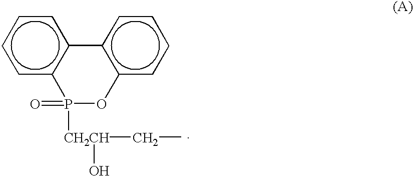

The functional group represented by the formula (A) in the phosphorus-containing resin of the invention is prepared by reacting the epoxy group of epoxy resin with 9,10-dihydro-9-oxa-10-phosphorusphenanthrene-10-oxide in the following formula (B):

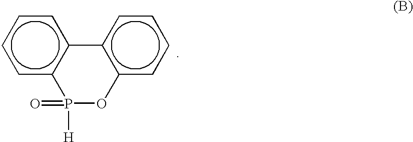

The phosphorus-containing resin of the invention is prepared by reacting conventional epoxy resin with 9,10-dihydro-9-oxa-10-phosphorusphenanthrene-10-oxide and optionally other compounds containing active hydrogen.

The epoxy resin for preparing the phosphorus-containing resin of the invention may be any epoxy resin, and examples of the epoxy resin include bisphenol diglycidyl ethers, bis(diphenol) glycidyl ethers, dihydroxybenzene glycidyl ethers, glycidyl ethers with a nitrogen-containing ring, dihydroxynaphthalene glycidyl ethers, phenolic polyglycidyl ethers, polyhydroxyphenol polyglycidyl ethers, etc.

Examples of bisphenol diglycidyl ethers include, for example, bisphenol A diglycidyl ether, bisphenol F diglycidyl ether, bisphenol AD diglycidyl ether, bisphenol S diglycidyl ether, tetramethyl bisphenol A diglycidyl ether, tetramethyl bisphenol F diglycidyl ether, tetramethyl bisphenol AD diglycidyl ether, tetramethyl bisphenol S diglycidyl ether, etc.

Examples of bis(diphenol) glycidyl ethers include, for example, 4,4′-diphenol glycidyl ether, 3,3′-dimethyl-4,4′-diphenol glycidyl ether, 3,3′,5,5′-tetramethyl-4,4′-diphenol glycidyl ether, etc.

Examples of dihydroxybenzene glycidyl ethers include, for example, resorcinol glycidyl ether, quinol glycidyl ether, isobutylquinol glycidyl ether, etc.

Examples of phenolic polyglycidyl ethers include, for example, phenolic polyglycidyl ether, cresol phenolic polyglycidyl ether, bisphenol A phenolic polyglycidyl ether, etc.

Examples of polyhydroxyphenol polyglycidyl ethers include, for example, tris(4-hydroxyphenyl)methane polyglycidyl ether, tris(4-hydroxyphenyl)ethane polyglycidyl ether, tris(4-hydroxyphenyl)propane polyglycidyl ether, tris(4-hydroxyphenyl)butane polyglycidyl ether, tris(3-methyl-4-hydroxyphenyl)methane polyglycidyl ether, tris(3,5-dimethyl-4-hydroxyphenyl)methane polyglycidyl ether, tetrakis(4-hydroxyphenyl)ethane polyglycidyl ether, tetrakis(3,5-dimethyl-4-hydroxyphenyl)ethane polyglycidyl ether, biscyclopentene-phenolic polyglycidyl ether, etc.

Examples of glycidyl ethers with a nitrogen-containing ring include, for example, triglycidyl ether of isocyanuric acid ester and triglycidyl ether of cyanuric acid ester.

Examples of dihydroxynaphthalene glycidyl ethers include, for example, 1,6-dihydroxynaphthalene diglycidyl ether and 2,6-dihydroxynaphthalene diglycidyl ether.

These epoxy resins may be used alone or in a mixture of two or more thereof.

Among them, bisphenol A diglycidyl ether, phenolic polyglycidyl ether, tris(4-hydroxyphenyl)methane polyglycidyl ether, biscyclopentene-phenolic polyglycidyl ether, tetrakis(phenyl-4-hydroxy)ethane polyglycidyl ether with four functional groups, or mixtures thereof are preferable.

The other compounds containing active hydrogen optionally used for preparing the phosphorus-containing resin of the invention include amines, bisphenol resins, dihydroxybenzenes, polyhydroxyphenol resins, phenolics, etc.

Examples of amines include, for example, dicyanodiamide, diaminodiphenylmethane, etc.

Examples of bisphenol resins include, for example, the compound represented by HO—Ph—X—Ph—OH (wherein Ph represents a phenyl group and X represents —CH₂—, —C(CH₃)₂—, —O—, —S—, —CO— or —SO₂—), such as bisphenol A, bisphenol F, bisphenol AD, bisphenol S, tetramethyl bisphenol A, tetramethyl bisphenol F, tetramethyl bisphenol AD, tetramethyl bisphenol S, 4,4′-diphenol, 3,3′-dimethyl-4,4′-diphenol, 3,3′,5,5′-tetramethyl-4,4′-diphenol, etc.

Examples of dihydroxybenzenes include, for example, resorcinol, quinol, isobutylquinol, etc.

Examples of polyhydroxyphenol resins include, for example, tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, etc.

Suitable examples of phenolics include, for example, phenol-formaldehyde condensate, cresol phenolic condensate, bisphenol A phenolic condensate, biscyclopentene-phenolic condensate, etc.

In the process of preparing the phosphorus-containing resin of the invention, the ratio of the above component is epoxy equivalent weight of epoxy resin:active hydrogen equivalent weight of the formula (B) compound:active hydrogen equivalent weight of the other compound containing active hydrogen=100:(5 to 50):(0 to 45), preferably 100:(10 to 50):(0 to 45), more preferably 100:(15 to 40):(0 to 45). If the content of the formula (B) compound is too high, the resin solution will become more viscous. If the content of the formula (B) compound is too low, the flame retardant property of the hardened product will be deteriorated. If the content of the other compound containing active hydrogen is too high, the resin will be significantly increased in molecular weight, which may make the phosphorus-containing epoxy resin become hardened and invalid for use.

During preparing the phosphorus-containing resin of the invention, in addition to the above components, catalysts may be added to help carry out the reaction. The catalysts include tertiary amines, tertiary phosphines, quaternary ammonium salts, quaternary phosphonium salts, boron trifluoride complex, lithium compounds, imidazole compounds, and mixtures thereof.

Examples of tertiary amines include, for example, triethylamine, tributylamine, dimethylaminoethanol, dimethylphenylamine, tris(N,N-dimethylaminomethyl)phenol, N,N-dimethylaminocresol, etc.

Examples of tertiary phosphines include, for example, triphenyl phosphine, etc.

Examples of quaternary ammonium salts include, for example, tetramethyl ammonium chloride, tetramethyl ammonium bromide, tetramethyl ammonium iodide, triethyl benzyl ammonium chloride, triethyl benzyl ammonium bromide, triethyl benzyl ammonium iodide, etc.

Examples of quaternary phosphonium salts include, for example, tetrabutyl phosphonium chloride, tetrabutyl phosphonium bromide, tetrabutyl phosphonium iodide, tetrabutyl phosphonium acetate-acetic acid complex, tetraphenyl phosphonium chloride, tetraphenyl phosphonium bromide, tetraphenyl phosphonium iodide, ethyl triphenyl phosphonium chloride, ethyl triphenyl phosphonium bromide, ethyl triphenyl phosphonium iodide, ethyl triphenyl phosphonium acetate-acetic acid complex, propyl triphenyl phosphonium chloride, propyl triphenyl phosphonium bromide, propyl triphenyl phosphonium iodide, butyl triphenyl phosphonium chloride, butyl triphenyl phosphonium bromide, butyl triphenyl phosphonium iodide, etc.

Examples of imidazole compounds include, for example, 2-methylimidazole, 2-phenylimidazole, 2-ethyl-4-methylimidazole, etc.

These catalysts may be used alone or in combination of two or more thereof.

The preferable catalysts are tertiary amines and imidazole compounds, especially dimethylphenylamine, 2-methylimidazole, 2-phenylimidazole, 2-ethyl-4-methylimidazole, etc.

The catalyst is used in an amount of 50 to 50,000 ppm, preferably 100 to 30,000 ppm, more preferably 200 to 10,000 ppm, and most preferably 500 to 2,000 ppm, based on the total weight of the starting material. If the amount of the catalyst is greater than 50,000 ppm, the reaction time is shortened. However, it may generate some by-products and a negative effect on electrical properties, humidity resistance and moisture absorption in subsequent applications such as a laminated circuit board. If the amount of the catalyst is smaller than 50 ppm, the reaction rate will be too slow to be efficient.

The reaction for preparing the phosphorus-containing resin of the invention may be carried out as a melting addition reaction in the absence of a solvent or as a reflux reaction in the presence of a solvent.

Suitable solvents include organic aromatics, ketones, protonic solvents, ethers, esters, etc.

Suitable organic aromatics are, for example, toluene, xylene, etc.

Suitable ketones are, for example, acetone, methyl ethyl ketone, methyl isobutyl ketone, etc.

Suitable protonic solvents are, for example, N,N-dimethylformamide, N,N-diethylformamide, dimethylsulfoxide, etc.

Suitable ethers are, for example, ethylene glycol monomethyl ether, propylene glycol monomethyl ether, etc.

Suitable esters are, for example, ethyl acetate, ethyl isopropionate, propylene glycol monomethyl ether ethyl ester, etc.

The reaction temperature for preparing the phosphorus-containing resin of the invention is generally 50 to 350° C., preferably 50 to 300° C., more preferably 100 to 250° C., and most preferably 100 to 200° C. If the temperature is too high, an undesired reaction may occur, and the reaction rate may be difficult to control, as well as the resin may be accelerated in deterioration. If the temperature is too low, besides poor efficiency, the prepared resin may be more labile to temperature and consequently can not be readily used in a high temperature condition.

The present invention also relates to a flame retardant resin composition, which comprises (a) the phosphorus-containing resin of the present invention, (b) the hardener of the following formula (C), and (c) the hardening promoter:

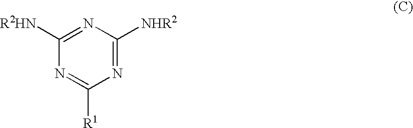

wherein R² represents —[CH₂—R³]ₙH (wherein n represents a integer of 0 to 20) or a hydrogen atom, provided that at least one of R² is not a hydrogen atom; R¹ represents NHR₂, a C₁₋₆ alkyl group or a phenyl group; and R³ represents a phenylene group, a naphthylene group or a group of the following formula:

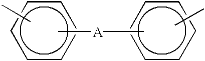

wherein A represents —O—, —S—, —SO₂—, —CO—, —CH₂—, —C(CH₃)₂— or a group of the following formula:

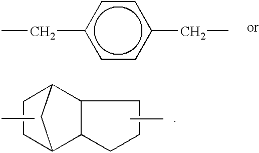

In the above-mentioned groups represented by R³ and A, the aromatic groups may further be substituted with one or more substituents selected from a hydroxy group, an amino group, a carboxy group and a C₁₋₆ alkyl group.

In the flame retardant resin composition of the invention, the hardening promoters include tertiary amines, tertiary phosphines, quaternary ammonium salts, quaternary phosphonium salts, boron trifluoride complex, lithium compounds, imidazole compounds or mixtures thereof

Examples of tertiary amines include, for example, triethylamine, tributylamine, dimethylaminoethanol, dimethylphenylamine, tris(N,N-dimethylaminomethyl)phenol, N,N-dimethylaminocresol, etc.

Examples of tertiary phosphines include, for example, triphenyl phosphine, etc.

Examples of quaternary ammonium salts include, for example, tetramethyl ammonium chloride, tetramethyl ammonium bromide, tetramethyl ammonium iodide, triethyl benzyl ammonium chloride, triethyl benzyl ammonium bromide, triethyl benzyl ammonium iodide, etc.

Examples of quaternary phosphonium salts include, for example, tetrabutyl phosphonium chloride, tetrabutyl phosphonium bromide, tetrabutyl phosphonium iodide, tetrabutyl phosphonium acetate-acetic acid complex, tetraphenyl phosphonium chloride, tetraphenyl phosphonium bromide, tetraphenyl phosphonium iodide, ethyl triphenyl phosphonium chloride, ethyl triphenyl phosphonium bromide, ethyl triphenyl phosphonium iodide, ethyl triphenyl phosphonium acetate-acetic acid complex, propyl triphenyl phosphonium chloride, propyl triphenyl phosphonium bromide, propyl triphenyl phosphonium iodide, butyl triphenyl phosphonium chloride, butyl triphenyl phosphonium bromide, butyl triphenyl phosphonium iodide, etc.

Examples of imidazole compounds include, for example, 2-methylimidazole, 2-phenylimidazole, 2-ethyl-4-methylimidazole, etc.

These hardening promoters may be used alone or in combination of two or more thereof.

The preferable hardening promoters are tertiary amines and imidazole compounds, especially dimethylphenylamine, 2-methylimidazole, 2-phenylimidazole, 2-ethyl-4-methylimidazole, etc.

The hardening promoter is used in amount of 50 to 50,000 ppm, preferably 100 to 30,000 ppm, more preferably 200 to 10,000 ppm, and most preferably 500 to 2,000 ppm, based on the weight of the epoxy resin composition. If the amount of the hardening promoter is higher than 50,000 ppm, the reaction time is shortened. However, it may generate some by-products and a negative effect electrical properties, humidity resistance and moisture absorption in subsequent applications such as a laminated circuit board. If the amount of the hardening promoter is lower than 50 ppm, the reaction rate will be too slow to be efficient.

The flame retardant resin composition of the invention, in addition to the phosphorus-containing resins of the invention, may also include other epoxy resins free of phosphorus.

The epoxy resin free of phosphorus may be any kind of epoxy resin, and the examples thereof include bisphenol diglycidyl ethers, bis(diphenol) glycidyl ethers, dihydroxybenzene glycidyl ethers, glycidyl ethers with a nitrogen-containing ring, dihydroxynaphthalene glycidyl ethers, phenolic polyglycidyl ethers, polyhydroxyphenol polyglycidyl ethers, etc.

Examples of bisphenol diglycidyl ethers include, for example, bisphenol A diglycidyl ether, bisphenol F diglycidyl ether, bisphenol AD diglycidyl ether, bisphenol S diglycidyl ether, tetramethyl bisphenol A diglycidyl ether, tetramethyl bisphenol F diglycidyl ether, tetramethyl bisphenol AD diglycidyl ether, tetramethyl bisphenol S diglycidyl ether, etc.

Examples of bis(diphenol) glycidyl ethers include, for example, 4,4′-diphenol glycidyl ether, 3,3′-dimethyl-4,4′-diphenol glycidyl ether, 3,3′,5,5′-tetramethyl-4,4′-diphenol glycidyl ether, etc.

Examples of dihydroxybenzene glycidyl ethers include, for example, resorcinol glycidyl ether, quinol glycidyl ether, isobutylquinol glycidyl ether, etc.

Examples of phenolic polyglycidyl ethers include, for example, phenolic polyglycidyl ether, cresol phenolic polyglycidyl ether, bisphenol A phenolic polyglycidyl ether, etc.

Examples of polyhydroxyphenol polyglycidyl ethers include, for example, tris(4-hydroxyphenyl)methane polyglycidyl ether, tris(4-hydroxyphenyl)ethane polyglycidyl ether, tris(4-hydroxyphenyl)propane polyglycidyl ether, tris(4-hydroxyphenyl)butane polyglycidyl ether, tris(3-methyl-4-hydroxyphenyl)methane polyglycidyl ether, tris(3,5-dimethyl-4-hydroxyphenyl)methane polyglycidyl ether, tetrakis(4-hydroxyphenyl)ethane polyglycidyl ether, tetrakis(3,5-dimethyl-4-hydroxyphenyl)ethane polyglycidyl ether, biscyclopentene-phenolic polyglycidyl ether, etc.

Examples of glycidyl ethers with a nitrogen-containing ring include, for example, triglycidyl ether of isocyanuric acid ester, triglycidyl ether of cyanuric acid ester, etc.

Examples of dihydroxynaphthalene glycidyl ethers include, for example, 1,6-dihydroxynaphthalene diglycidyl ether, 2,6-dihydroxynaphthalene diglycidyl ether, etc.

These epoxy resins may be used alone or in a mixture of two or more thereof.

Among them, bisphenol A diglycidyl ether, phenolic polyglycidyl ether, tris(4-hydroxyphenyl)methane polyglycidyl ether, biscyclopentene-phenolic polyglycidyl ether, tetrakis(phenyl-4-hydroxy)ethane polyglycidyl ether with four functional groups, or mixtures thereof are preferable.

When the epoxy resin free of phosphorus is used, the phosphorus-containing resin of the invention is used in an amount of 5 to 100%, preferably 20 to 100%, and more preferably 25 to 100%, based on the total weight of the epoxy resin. If the amount is too low, insufficient flame retardant properties and heat resistance may easily occur.

The flame retardant resin composition of the invention, in addition to the compound of the above formula (C), may also include other hardeners such as amines, bisphenol resins, dihydroxybenzenes, polyhydroxyphenol resins, phenolics, etc. Examples of amines include, for example, dicyanodiamide, diaminodiphenylmethane, etc.

Examples of bisphenol resins include, for example, the compound represented by HO—Ph—X—Ph—OH (wherein Ph represents a phenyl group and X represents —CH₂—, —C(CH₃)₂—, —O—, —S—, —CO— or —SO₂—), such as bisphenol A, bisphenol F, bisphenol AD, bisphenol S, tetramethyl bisphenol A, tetramethyl bisphenol F, tetramethyl bisphenol AD, tetramethyl bisphenol S, 4,4′-diphenol, 3,3′-dimethyl-4,4′-diphenol, 3,3′,5,5′-tetramethyl-4,4′-diphenol, etc.

Examples of dihydroxybenzenes include, for example, resorcinol, quinol, isobutylquinol, etc.

Examples of polyhydroxyphenol resins include, for example, tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, etc.

Suitable examples of phenolics include, for example, phenol-formaldehyde condensate, cresol phenolic condensate, bisphenol A phenolic condensate, biscyclopentene-phenolic condensate, etc.

When other hardeners are used, the formula (C) compound as a hardener is used in an amount of 5 to 100%, preferably 20 to 100%, and more preferably 25 to 100%, based on the total weight of the hardeners. If the amount is too low, insufficient flame retardant properties and heat resistance may easily occur.

In the flame retardant resin composition of the invention, the amount of the hardeners is added according to the active hydrogen equivalent weight of each hardener and the epoxy equivalent weight of the epoxy resin. The active hydrogen equivalent weight of the hardener is preferably from 20 to 140%, more preferably from 40 to 95%, and even more preferably from 50 to 95%, related to the epoxy equivalent weight of the epoxy resin of 100%.

When the flame retardant resin composition of the invention is formulated to a varnish, solvents may be added for adjusting the viscosity thereof. Suitable solvents include organic aromatics, ketones, protonic solvents, ethers, esters, etc.

Suitable organic aromatics are, for example, toluene, xylene, etc.

Suitable ketones are, for example, acetone, methyl ethyl ketone, methyl isobutyl ketone, etc.

Suitable protonic solvents are, for example, N,N-dimethylformamide, N,N-diethylformamide, dimethylsulfoxide, etc.

Suitable ethers are, for example, ethylene glycol monomethyl ether, propylene glycol monomethyl ether, etc.

Suitable esters are, for example, ethyl acetate, ethyl isopropionate, propylene glycol monomethyl ether ethyl ester, etc.

The viscosity is usually adjusted to be within the range of 20 to 500 cps/25° C.

Depending on the final use, the epoxy resin composition of the invention may also be incorporated with conventional additives or modifiers, such as heat stabilizers, light stabilizers, UV absorbents, plasticizers, etc.

The flame retardant resin composition of the invention may be manufactured into copper foils, fiber supports, and laminates of the flame retardant resin composition of the invention.

In formulate a varnish by using the flame retardant resin composition of the invention, immersed fiber substrates, for example, organic or inorganic fiber substrates such as glass fiber, metallic fiber, carbon fiber, aromatic amide fiber, boron and cellulose, etc. are heated to obtain a dried prepreg. The prepreg may further be formed into laminates of composite materials, or used alone in adhesive layers of other prepregs, or used as a combination of one or more prepregs with copper foil placed on one or both sides thereof Subsequently, by heating the prepreg or the combination thereof under pressure, the laminates of composite materials can be obtained, which are superior to the standards of the current products in size stability, resistance to chemicals, resistance to corrosion, moisture absorption and electrical properties, and are suitably used for producing electrical products used in electronics, space and public transit, such as in manufacturing printed circuit boards and multi-layer circuit boards, etc.

The varnish formulated by using the flame retardant resin composition of the invention can also be coated on a copper foil and dried by heating to obtain dried resin coated copper (RCC). The resin coated copper has good storage stability to be stored at room temperature for several months. The RCC may further be formed into laminates of composite materials, or used alone in adhesive layers of other prepregs, or used in a combination of one or more thereof with one or both sides thereof being laminated by means of a build-up process. The resultant laminates of composite materials are superior to the standards of the current products in size stability, resistance to chemicals, resistance to corrosion, moisture absorption and electrical properties, and are suitably used for producing printed circuit boards used in electronics, space and public transit, etc.

The reaction temperature suitable for hardening the flame retardant resin composition of the invention is 20 to 350° C., preferably 50 to 300° C., more preferably 100 to 250° C., and most preferably 120 to 220° C. If the temperature is too high, an undesired reaction may occur, the reaction rate may be difficult to control, and the resin may be accelerated in deterioration. If the temperature is too low, besides poor efficiency, the produced resin will be more labile to temperature and consequently can not be readily used in a high temperature condition.

The flame retardant resin composition of the invention may simultaneously improve the flame retardant property and the heat resistance of the epoxy resin without the need of adding other processing auxiliaries and flame retardant additives.

The present invention will be further described with reference to the following synthesis examples and examples. However, the scope of the present invention is not restricted by such examples.

### EXAMPLE

Components used in the following synthesis examples and examples respectively are described in details as follows:

Epoxy Resin 1 is cresol-aldehyde condensate polyglycidyl ether, wherein the epoxy equivalent weight thereof is from 200 to 220 g/eq and the amount of hydrolysable chlorine is less than 700 ppm (ASTM method), commercially available under the trademark CNE200ELB from Chang Chun Plastic Co., Ltd. Taiwan R.O.C.

Epoxy Resin 2 is phenolic polyglycidyl ether, wherein the epoxy equivalent weight thereof is from 170 to 190 g/eq and the amount of hydrolysable chlorine is less than 1000 ppm (ASTM method), commercially available under the trademark PNE177 from Chang Chun Plastic Co., Ltd. Taiwan R.O.C.

Epoxy Resin 3 is bisphenol A diglycidyl ether, wherein the epoxy equivalent weight thereof is from 185 to 195 g/eq, the amount of hydrolysable chlorine is less than 200 ppm, and the viscosity is from 11000 to 15000 cps/25° C., commercially available under the trademark BE188EL from Chang Chun Plastic Co., Ltd. Taiwan R.O.C.

Epoxy Resin 4 is available under the trademark BE501 from Chang Chun Plastic Co., Ltd. Taiwan R.O.C., wherein the epoxy equivalent weight thereof is from 490 to 510 g/eq.

Epoxy Resin 5 is tetrabeomobisphenol A diglycidyl ether, wherein the epoxy equivalent weight thereof is from 430 to 450 g/eq and the bromine content is from 18.5 to 20.5% by weight, commercially available under the trademark BEB530A80 from Chang Chun Plastic Co., Ltd. Taiwan R.O.C.

HCA is 9,10-dihydro-9-oxa-10-phosphorusphenanthrene-10-oxide, available under the trademark DOPO from Forte Chemical Co., Ltd.

Catalyst (hardening promoter) A is ethyltriphentlphosphonium acetate acetic acid complex (10% solution in methanol).

Catalyst (hardening promoter) B is 2-methylimidazole (2MI) (10% solution in methyl ethyl ketone).

Nitrogen-Containing Hardener A is dicyanodiamide (10% solution in dimethylformamide).

Nitrogen-Containing Hardener B is available under the trademark melan

9000^{TM70} from Hitachi Chemical Co., Ltd.

Nitrogen-Containing Hardener C is a nitrogen-containing hardener produced by Synthesis Example 5 (see below).

Hardener D is available under the trademark BEH510 from Chang Chun Plastic Co., Ltd. Taiwan R.O.C., wherein the active hydrogen equivalent weight thereof is from 105 to 110 g/eq.

The epoxy equivalent weight (EEW), the viscosity of varnish, and the solid content used herein are measured by the following methods:

(1) Epoxy equivalent weight (EEW): the EEW is measured by the ASTM D1652 method in which the epoxy resin is dissolved in a solvent of chlorobenzene:chloroform=1:1 and titrated with HBr/glacial acetic acid using crystal violet as an indicator.

(2) Viscosity: the viscosity of the phosphorus-containing epoxy resin varnish is measured at 25° C. using a Brookfield viscometer after placing the phosphorus-containing epoxy resin into a thermostat at 25° C. for 4 hours.

(3) Solid content: after baking 1 g of the phosphorus-containing epoxy resin varnish at 150° C. for 60 minutes, non-volatile content is measured and expressed in the form of percent by weight.

### Synthesis Example 1

### Synthesis of Phosphorus-Containing Resin A

Epoxy Resin 1 (1000 g) and HCA (400 g) were placed into a five-neck glass vessel (3000 ml), purged with nitrogen gas, and heated to 120° C., wherein the glass vessel is equipped with an electric heating jacket, a thermocontroller, an automatic agitator and stirrer, a nitrogen inlet, a thermocouple, a water-cooled condenser and a feeding funnel. After Epoxy Resin 1 and HCA are completely melted, the melted material was dried under a vacuum, and then was introduced with nitrogen gas and treated under a vacuum again. The above procedure was repeated 2 times. When the temperature in the glass vessel was reduced to 85 to 90° C., Catalyst A (6.0 g) was added. The resin and the catalyst were stirred uniformly by using the agitator while nitrogen gas was introduced, and then the resultant mixture was heated to 160° C. and kept for 10 minutes. It was found that the reactant raised to 180° C. in temperature by gradually and continuously releasing heat. The reactant was kept at this temperature for 3 hours to obtain the phosphorus-containing resin A in which the epoxy equivalent weight was 453 g/eq and the theoretical phosphorus content was 4.1 wt %.

### Synthesis Example 2 to 4

The reaction was carried out using the components and weights listed in Table 1 according to a similar method as recited in Synthesis Example 1. However, the solvent shown in Table 1 was added to the resultant epoxy resin after finishing the reaction, and then the phosphorus-containing resin in a liquid state was obtained. The epoxy equivalent weight, the solid content and the theoretical phosphorus content of the phosphorus-containing resin obtained from Synthesis Example 2 to 4 are shown in Table 2.

TABLE 1
Synthetic formulation in Synthesis Example 2 to 4

| | Synthesis Ex. 2 | Synthesis Ex. 3 | Synthesis Ex. 4 |
|---|---|---|---|
| | Epoxy Resin B | Epoxy Resin C | Epoxy Resin D |
| Epoxy Resin 1 (g) | 1000 | | |
| Epoxy Resin 2 (g) | | 1000 | 454.5 |
| Epoxy Resin 3 (g) | | | 448.8 |
| HCA (g) | 320 | 320 | 145.5 |
| Bisphenol A (g) | | | 139.3 |
| Hardening Promoter A (g) | 6.0 | 6.0 | 5.4 |
| Proptlene glycol monoether | 450 | 300 | 520.0 |
| acetate (ml) | | | |
| Acetone (ml) | 450 | 595 | |

TABLE 2
Properties of the phosphorus-containing epoxy resin

| | Epoxy Resin B | Epoxy Resin C | Epoxy Resin D |
|---|---|---|---|
| Epoxy equivalent weight (g/eq) | 403 | 378 | 451 |
| Solid content | 59.8% | 60.1% | 59.7% |
| Theoretical phosphorus content | 3.48% | 3.48% | 1.76% |

### Synthesis Example 5

### Synthesis of Phosphorus-Containing Resin C

Phenol (1269 g), formaldehyde (37.4%, 541.5 g), melamine (204 g) and triethylamine (10.2 g) were placed into a five-neck glass vessel (3000 ml) equipped with an electric heating jacket, a thermocontroller, a automatic agitator and stirrer, a nitrogen inlet, a thermocouple, a water-cooled condenser and a feeding funnel. The temperature was raised to 80 to 85° C., and the reaction was conducted for 3 hours. Melamine (204 g) was added, and the reaction was further conducted for 1 hour. After completing the reaction, the mixture was gradually raised to a temperature of 100° C. while water was removed, and then the mixture was raised again in temperature to 120 to 125° C. and the reaction was conducted 2 hours. After finishing the reaction, the nonreactive phenol and water condensed by the reaction were slowly distilled and removed under ambient pressure, and finally the reactant was kept for 1 hour at 180° C. under a vacuum. The resultant product was Nitrogen-Containing Hardener B (984 g) in which the theoretical nitrogen content was 13.4 wt % and the active hydrogen equivalent weight was 125 g/eq.

### Example 1 to 7 and Comparative Example 1

Epoxy Resins B, C and D synthesized in Synthesis Examples 2 to 4 respectively, and hardeners, hardening promoters and a solvent were placed in a container equipped with a stirrer and a condenser for formulating an epoxy resin varnish at room temperature in a ratio as shown in Table 3.

TABLE 3

| | | | | | | | |
|---|---|---|---|---|---|---|---|
| | | | | | | | Comp. |
| Ex. 1 | Ex. 2 | Ex. 3 | Ex. 4 | Ex. 5 | Ex. 6 | Ex. 7 | Ex. 1 |

Varnish Formulations

| | | | | | | | | |
|---|---|---|---|---|---|---|---|---|
| Epoxy Resin | 150 | | | | | | | |
| B (g) | | | | | | | | |
| Epoxy Resin | | 150 | 150 | 150 | | | | |
| C (g) | | | | | | | | |
| Epoxy Resin | | | | | 200 | 200 | 200 | |
| D (g) | | | | | | | | |
| Epoxy Resin | 153 | 147 | 147 | 147 | | | | |
| 4 (g) | | | | | | | | |
| Epoxy Resin | | | | | | | | 125 |
| 5 (g) | | | | | | | | |
| Hardener A | | | | | | | | 26.5 |
| (g) | | | | | | | | |
| Hardener B | 65 | | | 50 | | | 58 | |
| (g) | | | | | | | | |
| Hardener C | | 65 | | | 50 | | | |
| (g) | | | | | | | | |
| Hardener D | | | 65 | | | 50 | | |
| (g) | | | | | | | | |
| Hardening | 1.8 | 2.4 | 0.9 | 0.6 | 0.6 | 0.6 | 0.6 | 0.6 |
| Promoter | | | | | | | | |
| B (g) | | | | | | | | |

A glass fiber cloth was immersed into the formulated epoxy resin vanish, and then dried at a temperature of 150° C. for 120 minutes to form a prepreg. The glass transition temperature of the resultant prepreg was measured by a DSC (differential scan calorimeter, TA2910) at a temperature ranging from 50 to 250° C. and a temperature elevation rate of 20° C./min. The flame retardant property of the resultant prepreg was also measured by a burning test according to a UL746 method in which the prepreg was cut into 5 pieces (12.5 mm×1.3 mm) and each piece was burned twice. The burning test was passed when the sum of ten times of burning was not more than 50 seconds and single time of burning was not more than 10 seconds. The results are shown in Table 4.

TABLE 4
The flame retardent property and the glass transition temperature after baking
the prepreg at 150° C. for 120 minutes

| | | | | | | | | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 1 |
| Average Burning | 2 to 3 | 0 to 1 | Burning | 2 to 3 | 2 to 3 | Burning | 5 to 6 | 2 to 3 |
| Time (sec) | | | | | | | | |
| Tg (° C.) | 191.8 | 195.3 | 195.5 | 195.3 | 193.5 | 192.6 | 189.1 | 134.8 |

Eight prepregs were laminated with a copper foil having a thickness of 35 μm placed on the top and the bottom respectively at a temperature of 185° C. under a pressure of 25 kg/cm² to obtain a laminate of the epoxy resin and the glass fiber cloth. Each layer of the laminate was subjected to physical tests and the results are shown in Table 5.

TABLE 5

| | | | | | Comp. Ex. |
|---|---|---|---|---|---|
| Test Item | Cond. And Spec. | Ex. 1 | Ex. 4 | Ex. 7 | 1 |
| Flame Test | UL 94V-0 | passed | passed | passed | passed |
| Solder Resistance | IPC 288° C. spec. > | passed | passed | passed | failed |
| | 30 sec. | | | | |
| Peeling Strength | IPC spec. > 8 lb/in | 8.9 | 8.6 | 8.7 | 9.3 |
| Surface Resistance | IPC spec. > 10¹⁰ Ω | 2.68 × 10¹⁵ | 1.98 × 10¹⁵ | 2.63 × 10¹⁵ | 3.57 × 10¹⁵ |
| Volume Resistance | IPC spec. > 10¹⁰ Ω | 0.89 × 10¹³ | 1.81 × 10¹³ | 1.16 × 10¹⁴ | 1.06 × 10¹⁴ |
| Dielectric Constant | IPC spec. < 5.4 | 4.7 | 4.8 | 4.7 | 4.7 |
| Loss Factor | — | 0.022 | 0.021 | 0.020 | 0.020 |

### Example 8 to 11 and Comparative Example 2

The components shown in Table 6 were placed in the container equipped with a stirrer and a condenser for formulating at room temperature an epoxy resin varnish in a ratio shown in Table 6.

TABLE 6

| | | | | |
|---|---|---|---|---|
| Ex. 8 | Ex. 9 | Ex. 10 | Ex. 11 | Comp. Ex. 2 |

Varnish Formulations

| | | | | | |
|---|---|---|---|---|---|
| Epoxy Resin A (g) | 105 | | | | |
| Epoxy Resin B (g) | | 150 | | | |
| Epoxy Resin C (g) | | | 150 | | |
| Epoxy Resin D (g) | | | | 200 | |
| Epoxy Resin 4 (g) | 153 | 147 | 147 | | |
| Epoxy Resin 5 (g) | | | | | 125 |
| Hardener A (g) | | | | | 26.5 |
| Hardener C (g) | 68 | 65 | 68 | 96 | |
| Hardening Promoter B | 2.4 | 0.9 | 0.6 | 0.6 | 0.65 |
| (g) | | | | | |

The epoxy resin compositions obtained from the above Examples 8, 10 and 11 and Comparative Example 2 were coated at a thickness of 80 μm on a rough surface of copper foil having a thickness of 18 μm, and then dried at a temperature of 150° C. Each resultant copper foil coated with the epoxy resin was placed on the top and the bottom of the prepreg obtained from the epoxy resin composition in Example 1, and then laminated at a temperature of 185° C. under a pressure of 25 kg/cm² to obtain a multi-layer board. This multi-layer board was subjected to a series of physical tests, and the results of which are shown in Table 7.

TABLE 7

| Test Item | Cond. And Spec. | Ex. 9 | Ex. 10 | Ex. 11 | Comp. Ex. 2 |
|---|---|---|---|---|---|
| Flame Test | UL 94V-0 | passed | passed | passed | passed |
| Solder Resistance | IPC 288° C. spec. > 30 sec. | passed | passed | passed | passed |
| Peeling Strength | IPC spec. > 8 lb/in | 7.6 | 7.4 | 8.0 | 8.4 |

The above results show that, compared with the epoxy resin free of phosphorus, the phosphorus-containing epoxy resin of the present invention has better flame retardant and solder resistance properties, while the peeling strength thereof is not reduced.

What is claimed is:

1. A phosphorus-containing resin, characterized in a functional group of the following formula (A): 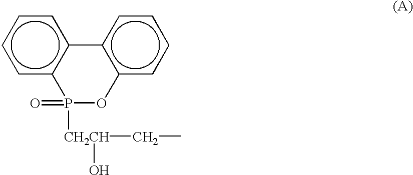
wherein the functional group is obtained by reacting an epoxy group of epoxy resin with 9,10-dihydro-9-oxa-10-phosphorusphenanthrene-10-oxide of the following formula (b):

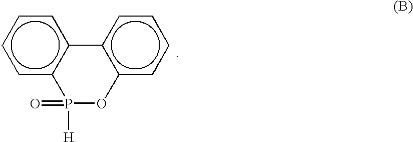

2. The phosphorus-containing resin of claim 1, which is further obtained by reacting the epoxy resin with 9,10-dihydro-9-oxa-10-phosphorusphenanthrene-10-oxide and an optional compound containing active hydrogen.

3. The phosphorus-containing resin of claim 2, wherein the epoxy resin is selected from a group consisting of bisphenol diglycidyl ethers, bis(diphenol) glycidyl ethers, dihydroxybenzene glycidyl ethers, glycidyl ethers with a nitrogen-containing ring, dihydroxynaphthalene glycidyl ethers, phenolic polyglycidyl ethers, and polyhydroxyphenol polyglycidyl ethers.

4. The phosphorus-containing resin of claim 2, wherein the optional compound containing active hydrogen is selected from a group consisting of amines, bisphenol resins, dihydroxybenzenes, polyhydroxyphenol resins, and phenolics.

5. The phosphorus-containing resin of claim 2, wherein a ratio of the epoxy resin to the 9,10-dihydro-9-oxa-10-phosphorusphenanthrene-10-oxide to the optional compound containing active hydrogen is 100 in epoxy equivalent weight:(5 to 50) in active hydrogen equivalent weight:(0 to 45) in active hydrogen equivalent weight.

6. A flame retardant resin composition, comprising (a) the phosphorus-containing resin of any one of claims 1 to 5, (b) a hardener of the following formula (C), and (c) a hardening promoter: 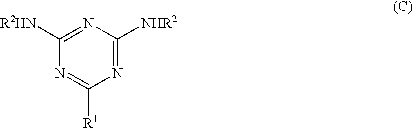
wherein R² represents —[CH₂—R³]ₙH (wherein n represents a integer of 0 to 20) or a hydrogen atom, while at least one of R² is not a hydrogen atom; R¹ represents NHR₂, a C₁₋₆ alkyl group or a phenyl group; and R³ represents a phenylene group, a naphthylene group or a group of the following formula: 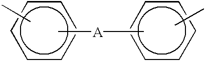
wherein A represents —O—, —S—, —SO₂—, —CO—, —CH₂—, —C(CH₃)₂— or a group of the following formula: 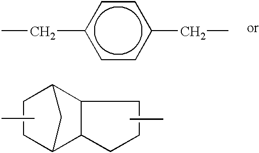
in the above-mentioned groups represented by R³ and A, the aromatic groups can further be substituted with one or more substituents selected from a hydroxy group, an amino group, a carboxy group and a C₁₋₆ alkyl group.

7. The flame retardant resin composition of claim 6, wherein the hardening promoters is selected from a group consisting of tertiary amines, tertiary phosphines, quaternary ammonium salts, quaternary phosphonium salts, boron trifluoride comlex, lithium compounds, and imidazole compounds and mixtures thereof

8. The flame retardant resin composition of claim 6, wherein the epoxy resin is further selected from a group consisting of bisphenol diglycidyl ethers, bis(diphenol) glycidyl ethers, dihydroxybenzene glycidyl ethers, glycidyl ethers with a nitrogen-containing ring, dihydroxynaphthalene glycidyl ethers, phenolic polyglycidyl ethers, and polyhydroxyphenol polyglycidyl ethers.

9. The flame retardant resin composition of claim 6, wherein the hardener is further selected from a group consisting of amines, bisphenol resins, dihydroxybenzenes, polyhydroxyphenol resins, and phenolics.

10. The flame retardant resin composition of any one of claims 6 to 9, wherein a ratio of the epoxy resin to the hardener is 100% in epoxy equivalent weight 20 to 140% in active hydrogen equivalent weight, and the hardening promoter is in an amount of 50 to 50,000 ppm based on the total weight of the epoxy resin composition.

11. The flame retardant resin composition of claim 6, which is used for producing prepregs, composite materials, laminates, printed circuit boards, substrates for build-up processes, or packaging materials of semiconductors.
